(19) United States
(12) Patent Application Publication
(10) Pub. No.: US 2008/0253554 A1
(43) Pub. Date: Oct. 16, 2008

(54) Flexible hanging-type earphone device

(76) Inventor: Landy Chen, Taipei Hsien (TW)

Correspondence Address: LANDY CHEN, 235 Chung-Ho, Box 8-24, Taipei, TW

(21) Appl. No.: 11/786,347

(22) Filed: Apr. 12, 2007

(51) Int. Cl. H04M 1/00

(52) U.S. Cl. 379/430

(57) ABSTRACT

A flexible hanging-type earphone device comprises a hollow earphone casing; a flexible shaft; a sound receiving seat; an electric wire enclosing set; a first connector; a second connector; and a volume control casing. The flexible hanging-type earphone device has a flexible shaft which be rotated radially and axially so as to fit the head shape of the user and make the user feel easy and have a preferred orientation for receiving and transmitting sounds. Furthermore the earphone has a compact structure which is suitable for carrying and storage. Moreover, it has a beautiful outlook which make the user feel comfortable and is beneficial commercially.

### FIELD OF THE INVENTION

The present invention relates to earphones, and particularly to a flexible hanging-type earphone device, wherein a flexible shaft can be rotated radially and axially so as to fit the head shape of the user, make the user feel easy and have a preferred orientation for receiving and transmitting sounds. Furthermore the present invention has a compact structure which is suitable for carrying and storage. Moreover, the present invention has a beautiful outlook which makes the user feel comfortable and is beneficial commercially.

### BACKGROUND OF THE INVENTION

In the prior art the earphone and microphone are separated, but for the web phone (for network phone communication), they must be combined to one device so that the user will feel easy and convenient in operation. In prior arts, the combination of the earphone and microphone is made as a helmet form, clip form or ear-plug form, etc. so that they can be used easily and conveniently.

Some prior patent has disclosed some earphones, for example, in U.S. Pat. No. 6,363,158, an adjustable hanging-type earphone is disclosed. The earphone comprises a main unit, a slide unit and a spring wire, wherein: the main unit, made of a rigid material, is shaped like a reversed “U” with an enclosed upper part and an opened lower part, protruding downward from its front being a speaker seat, on top of the speaker seat being a horizontal fixing shaft, at the rear of the speaker seat being a horizontal positioning shaft; the slide unit is shaped like a “C” figure, composed of a front rack, made of a rigid material, at its front part, and a rear rack, made of a flexible material, at its rear part; at the front of the front rack being a fixing hole, at the top of the rear rack being a positioning slot; the relative positions of the fixing hole and the positioning slot being designed to match the fixing shaft and the positioning shaft of the main unit; the top of the slide unit being inserted inside the main unit, to a position where the fixing shaft and the positioning shaft of the main unit are inserted into the fixing hole and the positioning slot of the slide unit and assembled as one unit; the spring wire is a flexible and tenacious, fine and long wire that can be bent or twisted freely; its front end being fastened to the top of the main unit, while the tail of the wire being free hanging.

In another prior art, U.S. Pat. No. 6,359,995 discloses an earphone fittable to both ears by hanging comprising: essentially a front main body and a rear insertion part; said front main body further including a housing with a vacancy spacing therein to form a battery compartment for a battery, a projected male connection port, a push button provided on said housing for supplying power from the battery, a pilot lamp, an earphone plug, and an engaging rim formed around the boundary of said housing where said rear insertion part being engaged; said rear insertion part further including a bayonet shank, a flexible earphone hanger, two tenons, and a recessed female connection port, said two tenons being respectively formed at the upper and the lower portions of said rear insertion part and each equipped with a claw tip so as to grip onto said front main body therewith thereby enclosing said battery in said housing, of the front body and said rear insertion part; with this structure, by pulling away said bayonet shank to separate said male and female connection ports, and overturning said bayonet shank about its own longitudinal axis 180.degree., and then coupling again said two connection ports, said earphone is now fittable for the other ear.

Above-mentioned prior arts disclose earphones which have rigid structures so that the shape of the earphone is fixed as it is fixed to the face.

The shape of the earphone is difficult to be adjusted. However, it is possible that the microphone is far away from the mouth of the user and thus the receiving effect is not good. Moreover, the user will feel uneasy due to the mounting position of the earphone.

### SUMMARY OF THE INVENTION

Accordingly, the primary object of the present invention is to provide a flexible hanging-type earphone device, wherein a flexible shaft can be rotated radially and axially so as to fit the head shape of the user and make the user feel easy and have a preferred orientation for receiving and transmitting sounds. Furthermore the present invention has a compact structure which is suitable for carrying and storage. The present invention has a beautiful outlook which make the user feel comfortable and is beneficial commercially.

To achieve above objects, the present invention provides a flexible hanging-type earphone device comprising: a hollow earphone casing having an enlarged hollowing head for receiving a audio player; a flexible shaft having one end which is connected to one end of the earphone casing; the flexible shaft being a long stripe and is made of flexible material; the flexible shaft being bendable axially and radially to have a desired shape so that the flexible hanging-type earphone device can fit the shape of the user's head; a sound receiving seat; one end of the sound receiving seat being connected to another end of the flexible shaft; a microphone being placed in the sound receiving seat for receiving the sound from the user; an electric wire enclosing set having one end extended from a lower end of the sound receiving seat and electric wires are received within the electric wire enclosing set; another end of the electric wire enclosing set being extended with two sub-electric-wire-enclosing sets through a connecting seat; a first connector, one sub-electric-wire-enclosing set being connected to the first connector for receiving sound signals; a second connector; another sub-electric-wire-enclosing set being connected to the second connector for transferring the signals from the microphone to a computer for further processing; and a volume control casing being installed at a middle section or near the middle section of the electric wire enclosing set for receiving a volume controller; the first connector being connected to the volume controller through an electric wire for transferring received signals from a computer or audio player to a speaker.

The various objects and advantages of the present invention will be more readily understood from the following detailed description when read in conjunction with the appended drawing.

### BRIEF DESCRIPTION OF THE DRAWINGS

FIG. 1 is an exploded perspective view of the present invention.

FIG. 2 is a perspective view of the present invention.

FIG. 3 is another perspective view showing the application of the present invention, where the flexible shaft is bent.

FIG. 4 is a schematic view showing the circuit of the sound receiving of the present invention.

FIG. 5 is a schematic view showing the circuit of the sound emitting of the present invention.

### DETAILED DESCRIPTION OF THE INVENTION

In order that those skilled in the art can further understand the present invention, a description will be provided in the following in details. However, these descriptions and the appended drawings are only used to cause those skilled in the art to understand the objects, features, and characteristics of the present invention, but not to be used to confine the scope and spirit of the present invention defined in the appended claims.

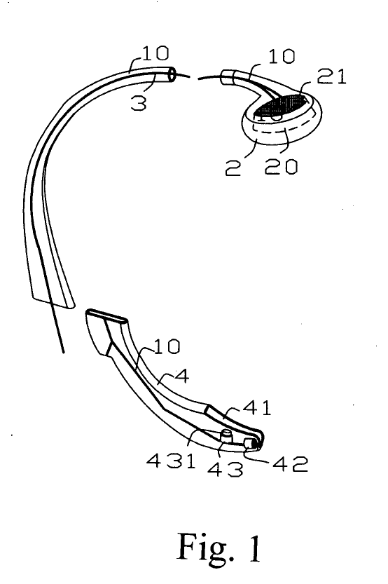

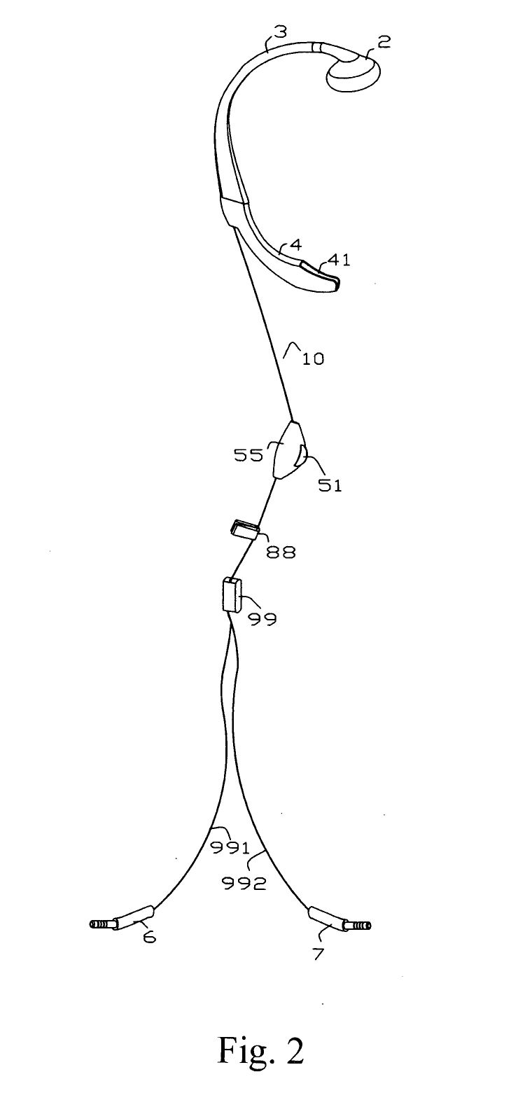

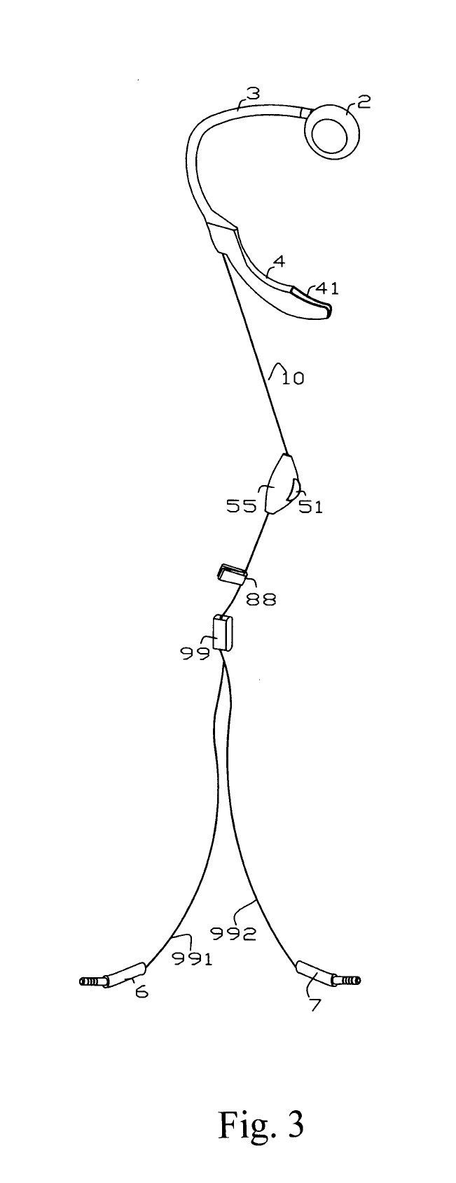

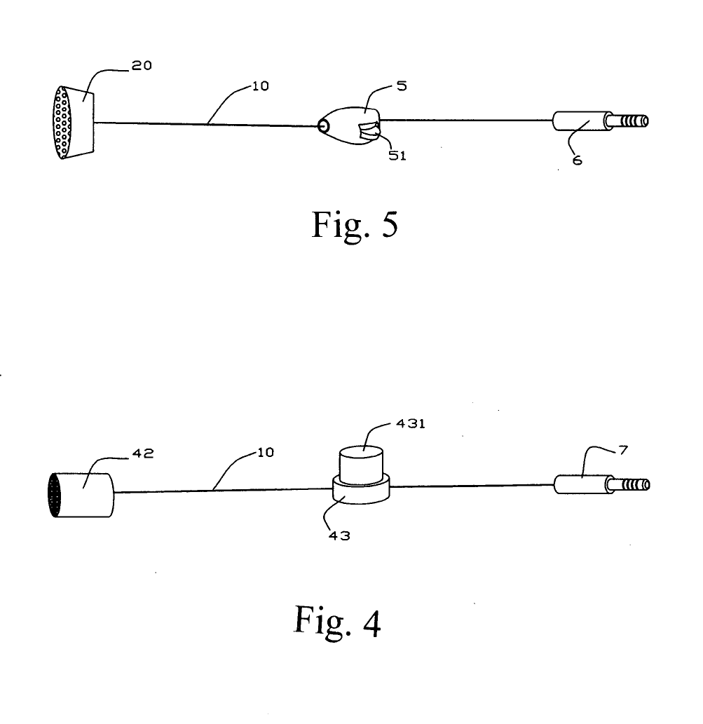

Referring to FIGS. 1 to 5, the flexible hanging-type earphone device of the present invention is illustrated. The present invention has the following elements.

A hollow earphone casing 2 has an enlarged hollowing head for receiving a audio player.

A flexible shaft 3 has one end connected to one end of the earphone casing 2. The flexible shaft 3 is a long stripe and is made of flexible material. The flexible shaft 3 is bendable axially and radially to have a desired shape so that the flexible hanging-type earphone device of the present invention can fit the shape of the user's head. Thus the user will feel comfortable and have a preferred receiving and emitting effect. Furthermore the flexible hanging-type earphone device can be shaped to be stored conveniently.

A sound receiving seat 4 is made of rigid material. One end of the sound receiving seat 4 is connected to another end of the flexible shaft 3. A lower side of the sound receiving seat 4 has a convex cambered shape and an upper side of the sound receiving seat 4 is formed with two connected concave cambered shapes. The sound receiving seat 4 has a hollow structure. An upper side of the sound receiving seat 4 has a button 431 (will be described below). A microphone 42 is placed in the sound receiving seat 4 for receiving the sound from the user.

An electric wire enclosing set 10 has one end extended from a lower end of the sound receiving seat 4 and electric wires are received within the electric wire enclosing set 10 (will be described below). Another end of the electric wire enclosing set 10 is extended with two sub-electric-wire-enclosing sets 991, 992 through a connecting seat 99. The sub-electric-wire-enclosing set 991 is connected to a first connector 6 for receiving sound signals. The sub-electric-wire-enclosing set 992 is connected to the second connector 7 for transferring the signals from the microphone 42 to a computer for further processing.

A volume control casing 55 is installed at a middle section (or near the middle section) of the electric wire enclosing set 10 for receiving a volume controller 5.

The circuit structure of the present invention will be described herein.

A audio player 2 includes an earphone receiver 20 and an earphone circuit 21 at a rear end of the earphone receiver 20.

The volume controller 5 is located within the volume control casing 55.

The audio player 2 is connected to the volume controller 5 through an electric wire. The volume controller 5 has a button 51 for controlling the volume of the emitting sound.

The first connector 6 is connected to the volume controller 5 through an electric wire for transferring received signals from a computer or audio player to a speaker 2.

The microphone 42 is positioned in the sound receiving seat 4 for receiving sound from the user and then converting the sound into signals for further processing.

A silence controller 43 is connected to the microphone 42. An upper side of the silence controller 43 has a button 431 for actuating the silence function of the silence controller 43 so that the microphone 42 can not receive sound signals.

The second connector 7 is connected to the silence controller 43 through an electric wire for transferring the sound signals from the microphone 42 to a computer or other sound processor.

A clip 88 has a hook which is fixed to the electric wire enclosing set 10.

The clip 88 serves to fix the electric wire enclosing set 10 to the body of the user (such as on the clothes of the user) so that the electric wire enclosing set 10 will not swing.

Advantages of the present invention are that the flexible shaft 3 can rotate radially and axially so as to fit the head shape of the user and make the user feel easy and have a preferred orientation for receiving and transmitting sounds. Furthermore the present invention has a compact structure which is suitable for carrying and storage. Moreover, the present invention has a beautiful outlook which makes the user feel comfortable and is beneficial commercially.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A flexible hanging-type earphone device comprising:
a hollow earphone casing having an enlarged hollowing head for receiving a audio player;
a flexible shaft having one end which is connected to one end of the earphone casing; the flexible shaft being a long stripe and is made of flexible material; the flexible shaft being bendable axially and radially to have a desired shape so that the flexible hanging-type earphone device can fit the shape of the user's head;
a sound receiving seat; one end of the sound receiving seat being connected to another end of the flexible shaft; a microphone being placed in the sound receiving seat for receiving the sound from the user;
an electric wire enclosing set having one end extended from a lower end of the sound receiving seat and electric wires are received within the electric wire enclosing set; another end of the electric wire enclosing set being extended with two sub-electric-wire-enclosing sets through a connecting seat;
a first connector, one sub-electric-wire-enclosing set being connected to the first connector for receiving sound signals;
a second connector; another sub-electric-wire-enclosing set being connected to the second connector for transferring the signals from the microphone to a computer for further processing; and
a volume control casing being installed at a middle section or near the middle section of the electric wire enclosing set for receiving a volume controller; the first connector being connected to the volume controller through an electric wire for transferring received signals from a computer or audio player to a speaker.

2. The flexible hanging-type earphone device as claimed in claim 1, further comprising:
an audio player including an earphone receiver and an earphone circuit at a rear end of the earphone receiver.

3. The flexible hanging-type earphone device as claimed in claim 1, wherein the volume controller is located within the volume control casing; and the audio player is connected to the volume controller through an electric wire.

4. The flexible hanging-type earphone device as claimed in claim 1, wherein the volume controller has a button for controlling the volume of the emitting sound.

5. The flexible hanging-type earphone device as claimed in claim 1, wherein the microphone is positioned in the sound receiving seat for receiving sound from the user and then converting the sound into signals for further processing.

6. The flexible hanging-type earphone device as claimed in claim 1, wherein the second connector is connected to a silence controller through an electric wire for transferring the sound signals from the microphone to a computer or other sound processor.

7. The flexible hanging-type earphone device as claimed in claim 1, further comprising:
a clip having a hook fixed to the electric wire enclosing set.

8. The flexible hanging-type earphone device as claimed in claim 1, wherein a lower side of the sound receiving seat having a convex cambered shape and an upper side of the sound receiving seat is formed with two connected concave cambered shapes.

9. The flexible hanging-type earphone device as claimed in claim 1, wherein a silence controller is connected to the microphone; and the silence controller has a button for actuating the silence function of the silence controller so that the microphone can not receive sound signals.
